(19) United States
(12) Patent Application Publication
(10) Pub. No.: US 2002/0108018 A1
(43) Pub. Date: Aug. 8, 2002

(54) Memory module control and status

(76) Inventor: Han-ping Chen, Saratoga, CA (US)

Correspondence Address: Han-ping Chen, P.O. Box 2871, Saratoga, CA, 95070, US

(21) Appl. No.: 09/775,607

(22) Filed: Feb. 5, 2001

(51) Int. Cl. G06F 12/00

(52) U.S. Cl. 711/115

(57) ABSTRACT

A method and apparatus controls the read-write accesses of a memory module, monitors the memory module status, generates module control signals, and arbitrates the read-write operations for a non-volatile memory that stores the memory characteristics, status, and control information.

### BACKGROUND OF THE INVENTION

This invention relates to semiconductor memory devices, memory chips, memory modules, and the control of memory components.

A computer system normally contains memory modules to provide the flexibility and expandability in memory size and functionality. This modular memory architecture is also more cost-effective. Common memory modules include single in-line memory modules (SIMMs) and dual in-line memory modules (DIMMs).

A memory module may contain fixed or variable settings to specify the type, size, speed, and manufacturer of the memory chips for the processing system to determine the customized memory parameters.

The memory settings may be hard-wired, in read-only memory (ROM), or in programmable read-only memory (PROM). It may also be in non-volatile memory, such as a Serial EEPROM, so that its content may be altered after placed in use.

However, the functionality and operational flexibility of a memory module is still limited even with the programmability of the non-volatile memory.

Regarding the customization of memory timing, such a memory module is still passive in nature. The control of the memory timing still largely depends on the computing system. Under certain conditions, some system boards still manifest timing exceptions when operating with specific types of memory modules.

If a memory module contains permanent or temporary component defects, in order to maintain the system functionality, the memory module requires even more sophisticated configuration control.

### BRIEF SUMMARY OF THE INVENTION

This invention proposes a method and apparatus to provide effective control signal generation and status monitoring for memory modules.

This invention provides a method and apparatus to monitor the status of control, address, and data signals on a memory module. It further provides a mechanism to report the status information to the computing system.

This invention also provides a method and apparatus to generate certain memory configuration and control signals locally on the memory module. These signals are based on parameters specified initially, collected locally, or received from the computing system.

This invention provides a method for a local memory control unit to share the same non-volatile memory for storing memory identification and access control settings.

The present invention provides a method to arbitrate the read-write accesses to the non-volatile memory between the computing system and the memory control unit.

This invention further provides a method that selectively protects the different regions of the non-volatile memory. Three major regions of the non-volatile memory are a memory identification region, a user-defined region, and a control-and-status region.

For a memory module containing permanent or temporary component defects, this invention provides a method to perform error detection and recovery in order to maintain the system functionality.

### BRIEF DESCRIPTION OF THE DRAWINGS

FIG. 1 is a diagram of a prior art memory module.

FIG. 2 is a preferred embodiment of the present invention for a memory module with a memory control unit.

FIG. 3 shows a preferred embodiment of the present invention for a memory control unit in connection with an edge connection and a non-volatile memory.

FIG. 4 shows a preferred embodiment of the present invention for a memory module.

FIG. 5 shows a preferred embodiment of the present invention for a memory control unit.

FIG. 6 shows another preferred embodiment of the present invention for a memory control unit

FIG. 7 shows a memory partition diagram for a non-volatile memory with three major regions.

### DETAILED DESCRIPTION OF THE INVENTION

The present invention will be illustrated with some preferred embodiments.

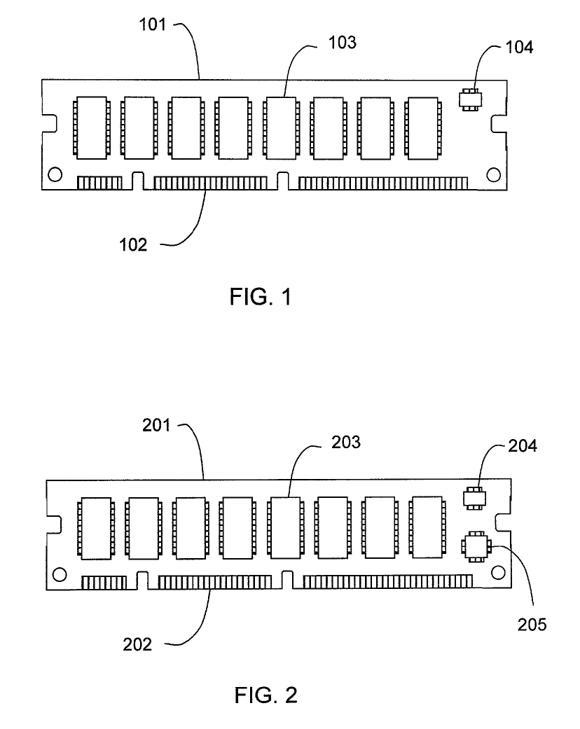

FIG. 1 is a diagram of a prior art memory module. The memory module is built on a printed circuit board 101 with an edge connection 102 to interface with other system components. This memory module contains a total of eight memory chips 103. A non-volatile memory chip 104 stores the type, size, speed of the memory chips.

FIG. 2 shows a preferred embodiment of the present invention for a memory module. In addition to a printed circuit board 201, an edge connection 202, eight memory chips 203, and a non-volatile memory chip 204, the memory module contains a memory control unit 205 to provide status monitoring, control signaling, and the arbitration for the read-write accesses of the non-volatile memory.

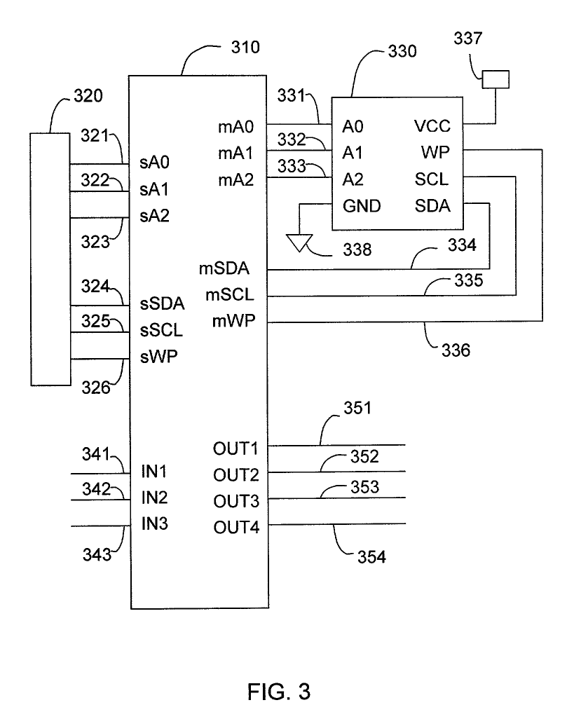

FIG. 3 shows a preferred embodiment of the present invention for a memory control unit 310 in connection with an edge connection 320 and a non-volatile memory 330.

The memory control unit 310 connects to the edge connection 320 with a system serial data line 324 and a system serial clock line 325. It also receives from the edge connection 320 a system write protection line 326 and three system address lines, 321, 322, and 323.

On the other side, the memory control unit 310 connects to the non-volatile memory 330 with a module serial data line 334 and a module serial clock line 335. It also sends to the non-volatile memory 330 a module write protection line 336 and three module address lines, 331, 332, and 333.

The non-volatile memory 330 is also connected to the power supply through point 337 and to the ground through point 338.

The memory control unit 310 may read data from the non-volatile memory 330 by supplying the necessary control signals to control lines 331, 332, 333, 334, 335, and 336. It receives non-volatile memory data from control line 334.

The memory control unit 310 may transfer the data it reads from the non-volatile memory 330 to system serial data line 324 on the edge connection 320 and make it available to the computing system.

The memory control unit 310 may receives incoming data signal from the computing system through the system serial data line 324 on the edge connection 320. It may also receive control signals on control lines 321, 322, 323, 324, 325, and 326 from the computing system through the edge connection 320.

The incoming data may be stored into the non-volatile memory 330 by supplying the necessary data and control signals to control lines 331, 332, 333, 334, 335, and 336.

The memory control unit 310 generates control signal outputs on control output lines 351, 352, 353, and 354. These control signals are derived from data stored in the non-volatile memory, signals retrieved from the memory devices, or signals received from the computing system.

The memory control unit 310 receives status signal inputs on status input lines 341, 342, and 343. These signals are collected from the memory devices or the computing system.

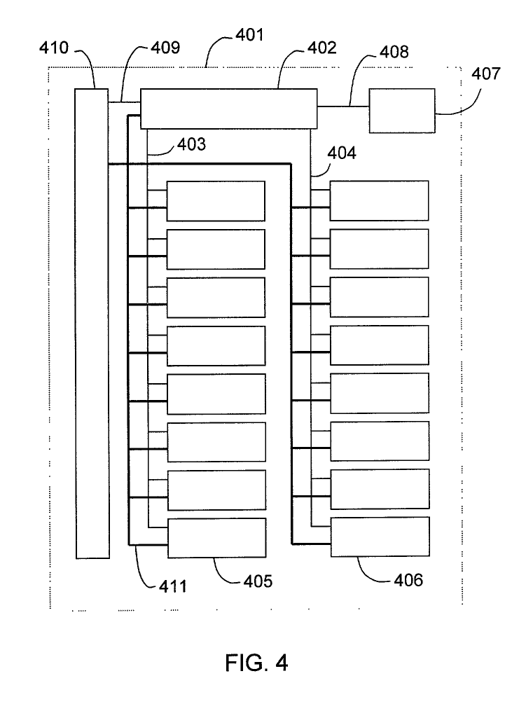

FIG. 4 shows a preferred embodiment of the present invention for a memory module. In memory module 401, the memory control unit 402 generates two control signals 403 and 404 for two groups of memory devices, a primary group 405 and a secondary group 406.

The address space of the memory devices is divided into eight memory blocks. For a memory read-write to a particular memory block, the control unit 402 selects either the primary memory group 405 or the secondary memory group 406.

The selection is based on whether the particular memory block in the primary memory group meets the functional requirements. If it does, the primary memory group is selected. If not, the secondary memory group is selected.

The status of the memory blocks is stored in the non-volatile memory 407, together with the memory identification information. The control unit 402 reads the status information through a serial data line 408. The computing system reads or writes the status information through the serial data line 409 and the module connection edge 410.

The module connection edge 410 also provides the address, data, and control signals 411 to the memory control unit and the memory devices.

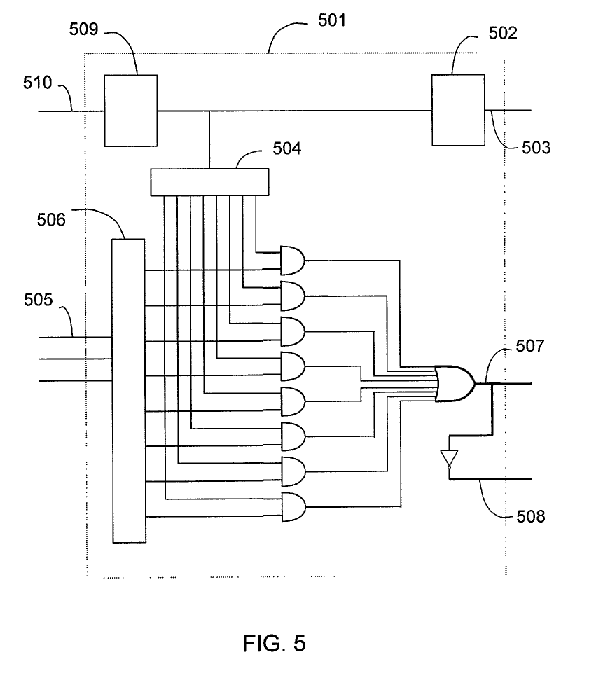

FIG. 5 shows a preferred embodiment of the present invention for a memory control unit for the memory module in FIG. 4.

In the non-volatile memory, there is a memory status table that contains eight status bit entries, one for each memory block. A status bit entry is a one if the corresponding primary memory block meets the functional requirements. It is a zero if the corresponding primary memory block does not meet the functional requirements.

In the memory control unit 501, the non-volatile memory interface unit 502 receives memory status information from the module serial data line 503. The memory control unit maintains the memory status bits in an internal memory status register 504.

The memory control unit 501 receives three memory block address input lines 505. A decoder logic block 506 decodes the three block address lines into eight memory block selection lines. Each block selection line is logically AND with the corresponding status bit line from the memory status register 504. These block status lines are logically OR together to form memory control lines 507 and 508. These memory control lines are used to select the appropriate group of memory devices.

The computing system may read or write the status information to the non-volatile memory through the module connection interface unit 509 and a system serial data line 510.

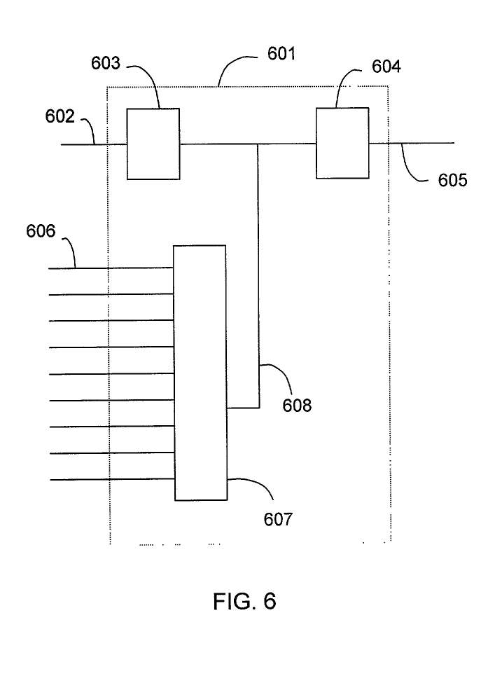

FIG. 6 shows another preferred embodiment for a memory control unit. In this embodiment, the computing system may perform read-write operation to the memory control unit 601 through the system serial data line 602 and the memory connection interface unit 603.

The read-write operation may be directed to the non-volatile memory through the memory interface unit 604 and the module serial data line 605.

In addition, the memory control unit 601 receives nine device data lines 606. An error detection circuit unit 607 analyzes the device data lines and generates an error status line 608.

The computing system may read this error status through the system read data path. The error status may also be written into the non-volatile memory using the memory write data path.

For memory modules that contain only data contacts and no error status contacts on the module connector, this preferred embodiment provides access to the error detection status through the serial data connection.

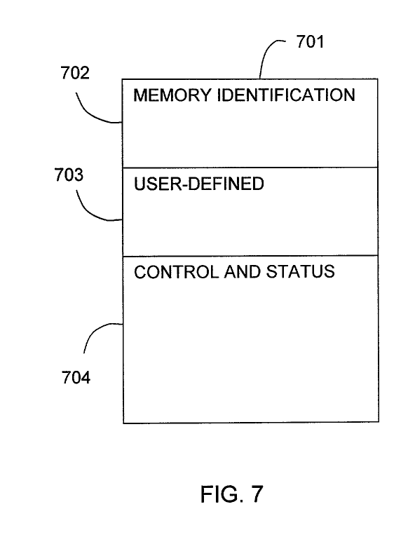

FIG. 7 shows a memory partition diagram for a non-volatile memory with three major regions. The three major regions of the non-volatile memory 701 are a memory identification region 702, a user-defined region 703, and a control-and-status region 704. The memory identification region and the control-and-status region are normally subject to write-protection to prevent from unexpected alteration by users.

I claim:

1. A memory module comprising:
(a) a module mounting surface having a plurality of module connection points;
(b) a memory control unit having a plurality of control points, at least a first of said control points is connected to a first module connection point through a connecting element;
(c) a non-volatile memory having a plurality of memory interface points, at least a first of said memory interface points is connected to a second control point through a connecting element;
(d) a plurality of volatile memory devices, each having a plurality of device interface points, at least one of which is connected to either a module connection point or a control point through a connecting element;
wherein a connecting element is a wire connection, a zero-impedance material or a low-impedance material;
wherein said non-volatile memory contains a plurality of non-volatile data, each containing a plurality of non-volatile bits;
wherein said memory control unit contains means for reading the content of a first non-volatile data from said first memory interface point through said second control point;
wherein said memory control unit also contains means for sending the content of said first non-volatile data through said first control point to said first module connection point;
wherein said memory control unit contains means for reading the content of a second non-volatile data from said first memory interface point through said second control point;
wherein said memory control unit also contains means for using at least said second non-volatile data to derive a control signal on a third control point, said third control point is not connected to any module connection point or memory interface point through a connecting element.

2. The memory module of claim 1, wherein said memory control unit and said non-volatile memory reside within the same chip assembly.

3. The memory module of claim 1, wherein said memory control unit further contains:
(a) means for receiving a first incoming data through said first control point from said first module connection point;
(b) means for writing said first incoming data to said non-volatile memory through said second control point and said first memory interface point.

4. The memory module of claim 3, wherein the writing of at least a portion of said non-volatile memory is enabled or disabled by a switch, a jumper, a wire connection, a zero-impedance material, a low-impedance material, a signal on a module connection point, a non-volatile data in said non-volatile memory, or a logic circuitry in said memory control unit.

5. The memory module of claim 1, wherein said third control point is connected to a device interface point through a connecting element.

6. The memory module of claim 1, wherein the signal on said third control point is also a function of a signal from a fourth control point.

7. The memory module of claim 6, wherein said fourth control point is connected to a second module connection point through a connecting element.

8. A memory module comprising:
(a) a module mounting surface having a plurality of module connection points;
(b) a memory control unit having a plurality of control points, at least a first of said control points is connected to a first module connection point through a connecting element;
(c) a non-volatile memory having a plurality of memory interface points, at least a first of said memory interface points is connected to a second control point through a connecting element;
(d) a plurality of volatile memory devices, each having a plurality of device interface points, at least one of which is connected to either a module connection point or a control point through a connecting element;
wherein a connecting element is a wire connection, a zero-impedance material or a low-impedance material;
wherein said non-volatile memory contains a plurality of non-volatile data, each containing a plurality of non-volatile bits;
wherein said memory control unit contains means for reading the content of a first non-volatile data from said first memory interface point through said second control point;
wherein said memory control unit also contains means for sending the content of said first non-volatile data through said first control point to said first module connection point;
wherein said memory control unit contains means for deriving a first status data using at least a signal on a third control point and means to send said first status data through said first control point to said first module connection point.

9. The memory module of claim 8, wherein said memory control unit and said non-volatile memory reside within the same chip assembly.

10. The memory module of claim 8, wherein said memory control unit further contains:
(a) means for receiving a first incoming data through said first control point from said first module connection point;
(b) means for writing said first incoming data to said non-volatile memory through said second control point and said first memory interface point.

11. The memory module of claim 10, wherein the writing of at least a portion of said non-volatile memory is enabled or disabled by a switch, a jumper, a wire connection, a zero-impedance material, a low-impedance material, a signal on a module connection point, a non-volatile data in said non-volatile memory, or a logic circuitry in said memory control unit.

12. The memory module of claim 8, wherein said third control point is connected to a device interface point or a module connection point through a connecting element.

13. A memory module comprising:
(a) a module mounting surface having a plurality of module connection points;
(b) a memory control unit having a plurality of control points, at least a first of said control points is connected to a first module connection point through a connecting element;
(c) a non-volatile memory having a plurality of memory interface points, at least a first of said memory interface points is connected to a second control point through a connecting element;
(d) a plurality of volatile memory devices, each having a plurality of device interface points, at least one of which is connected to either a module connection point or a control point through a connecting element;
wherein a connecting element is a wire connection, a zero-impedance material or a low-impedance material;
wherein said non-volatile memory contains a plurality of non-volatile data, each containing a plurality of non-volatile bits;
wherein said memory control unit contains means for reading the content of a first non-volatile data from said first memory interface point through said second control point;
wherein said memory control unit also contains means for sending the content of said first non-volatile data through said first control point to said first module connection point;
wherein said memory control unit contains means for writing a first status data derived from at least a signal on a third control point to said non-volatile memory through said second control point and said first memory interface point.

14. The memory module of claim 13, wherein said memory control unit and said non-volatile memory reside within the same chip assembly.

15. The memory module of claim 13, wherein said memory control unit further contains:
(a) means for receiving a first incoming data through said first control point from said first module connection point;
(b) means for writing said first incoming data to said non-volatile memory through said second control point and said first memory interface point.

16. The memory module of claim 15, wherein the writing of at least a portion of said non-volatile memory is enabled or disabled by a switch, a jumper, a wire connection, a zero-impedance material, a low-impedance material, a signal on a module connection point, a non-volatile data in said non-volatile memory, or a logic circuitry in said memory control unit.

17. The memory module of claim 13, wherein said third control point is connected to a device interface point or a module connection point through a connecting element.

18. A memory module comprising:
(a) a module mounting surface having a plurality of module connection points;
(b) a memory control unit having a plurality of control points, at least a first of said control points is connected to a first module connection point through a connecting element;
(c) a non-volatile memory having a plurality of memory interface points, at least a first of said memory interface points is connected to a second control point through a connecting element;
(d) a plurality of volatile memory devices, each having a plurality of device interface points, at least one of which is connected to either a module connection point or a control point through a connecting element;
wherein a connecting element is a wire connection, a zero-impedance material or a low-impedance material;
wherein said non-volatile memory contains a plurality of non-volatile data, each containing a plurality of non-volatile bits;
wherein said memory control unit contains means for reading the content of a first non-volatile data from said first memory interface point through said second control point;
wherein said memory control unit also contains means for sending the content of said first non-volatile data through said first control point to said first module connection point;
wherein said memory control unit contains means for receiving a first incoming data through said first control point from said first module connection point;
wherein said memory control unit also contains means for writing said first incoming data to said non-volatile memory through said second control point and said first memory interface point;
wherein said memory control unit contains means for enabling or disabling the writing of at least a first portion of said non-volatile memory;
wherein the enabling or disabling of the writing for said first portion of the non-volatile memory is controlled, at least in part, by a first non-volatile control bit;
wherein said memory control unit contains means for setting and resetting said first non-volatile control bit.

19. The memory module of claim 18, wherein said memory control unit and said non-volatile memory reside within the same chip assembly.

20. The memory module of claim 18, wherein the setting and resetting of said first non-volatile control bit is controlled by a signal on a third control point.

21. The memory module of claim 20, wherein said third control point is connected to a switch, a jumper, a wire connection, a zero-impedance material, a low-impedance material, or a signal on a module connection point.
